(19) United States
(12) Patent Application Publication
(10) Pub. No.: US 2006/0236155 A1
(43) Pub. Date: Oct. 19, 2006

(54) Remote control system and remote switch control method for blade servers

(75) Inventors: Chun-Liang Lee, Taipei (TW); Yu-Hui Chen, Taipei (TW); Chao-Hsien Hsu, San Jose, CA (US); Chunyi Liao, Palo Alto, CA (US)

Correspondence Address: BIRCH STEWART KOLASCH & BIRCH, PO BOX 747, FALLS CHURCH, VA, 22040-0747, US

(73) Assignee: INVENTEC CORPORATION and 3UP Systems, Inc.

(21) Appl. No.: 11/106,610

(22) Filed: Apr. 15, 2005

(51) Int. Cl. G06F 11/00

(52) U.S. Cl. 714/31

(57) ABSTRACT

A remote control system and remote switch control method for blade servers aims to switch different server blades and monitors and controls the server blades through a remote control station. The remote control system is connected to a baseboard management controller on a back plane, to form direct communication. When the remote control station sends a designated signal through the Internet to the remote control system, the remote control system transmits a switch signal to the. baseboard management controller through an internal bus, to switch a different server blade. The condition of the server blade is transmitted through the same route to the remote control station, to perform monitoring and control.

### FIELD OF THE INVENTION

The present invention relates to an improvement for blade server systems and control methods, particularly to a remote control system and remote switch control method for blade servers.

### BACKGROUND OF THE INVENTION

As information exchange grows constantly, many enterprises have integrated the distributed servers in a central data center to reduce the high cost of managing the distributed systems and management problems. A new type of server has been developed to meet this requirement. It is generally called the blade server. The blade server integrates the processor, memory and hard disk on a single main board that functions as a server system. Each main board is called a server blade. A number of server blades may be mounted onto a back plane to share the common resources, such as a chassis, power supply, keyboard, mouse and display device. The chassis can contain several or dozens of back planes, that have respectively held dozens of server blades. The blade server has advantages of being compact, saving space, being easy to manage and having lower total cost. It also can be configured and set up quickly, and can save about 20% of the set up time of conventional servers. It further can accommodate different operation systems, such as some sever blades with Intel processors, to provide document process and printing services, and some other server blades, like Linux clusters. Even different chip sets of server blades can coexist, such as Power architecture. It also overcomes many other limitations of the conventional servers. Hence the blade server is a trend many companies are adopting now.

However, the control center of the general server mostly is located nearby the server and connected to the server, to perform direct management and control. It requires people at the control center constantly, to fix problems generated by the server. Hence some dedicated people have to stay onsite all the time. This results in an extra manpower cost. To remedy this problem, remote control has been developed. It can directly control the server through the Internet without the constraint of the control center. When the server malfunctions, it may be fixed through the remote control. Hence the shut-down time of the server may be reduced. Nowadays, some blade servers also adopt remote control for monitoring, but are limited to the server blades provided by the control center. Other server blades cannot be switched, monitored and controlled. When managers are not in the control center, the management and monitoring cannot be done on other locations. There is still room for improvement.

### SUMMARY OF THE INVENTION

In view of the aforesaid problems, the primary object of the present invention is to provide a remote control system and remote switch control method for blade servers, that employs a remote control station and the Internet protocol (IP), to couple with a remote control center linking, backing planes of a blade server to transmit a switch signal, switching different back planes of the blade server and monitor and control the server blades.

The remote control system for blade servers according to the invention includes:

A blade server which has a back plane, holding a plurality of server blades. Each server blade has a baseboard management controller to control and manage the server blade and an onsite control station which is a monitor and switch equipment to monitor and control the blade server. The onsite control station is connected to the back plane of the blade server. When a plurality of blade servers and back planes is connected to the onsite control station, the onsite control station can switch each back plane and monitor and control each server blade. The onsite control station includes a keyboard, a video, a mouse, and a universal serial bus (USB) to perform monitor and control; and

A remote- control unit which is signal conversion and switch equipment. It is connected to the back plane of the blade server to communicate with the back plane, and transforms the back plane condition to an IP signal and transmits the signal to a remote control station. The remote control station is a monitor and controls equipment to receive the IP signal. It can communicate with the remote control unit in a two-way fashion through the Internet. When the remote control station transmits a designated instruction, the signal is sent to the remote control unit through the Internet. When the remote control unit receives the signal, it connects to a designated back plane, and the back plane connects to a designated server blade to perform monitoring and control. The remote control station also includes a keyboard, a video, a mouse, and a USB.

The onsite control station and the remote control station communicate with the baseboard management controller of the back plane through a transmission interface, such as an intellectual platform management bus (IPMB), serial port, parallel port, EIA interface standard RS-232, peripheral controller interface (PCI), or industry standard architecture (ISA).

Besides the remote control system for blade servers set forth above, the invention also provides a remote switch control method for blade servers that enables the remote control station to do two-way transmission with the remote control unit, and send a designated signal to the remote control unit.

As the remote control unit is connected to the baseboard management controller of the back plane of the blade server, when the remote control unit receives the designated signal, the remote control unit sends a switch signal to the baseboard management controller of the selected back plane. The baseboard management controller transmits the condition of the server blade to the remote control unit, which in turn transmits the condition to the remote control station through the Internet, thereby monitoring and controlling the selected server blade.

Hence if a plurality of blade servers is connected together, the back plane of each blade server has to be connected to a remote control unit and linked to the remote control station through the Internet. When the remote control station wants to monitor and control different blade servers, the remote control station is connected to the back plane of the blade server to be monitored and controlled. By repeating the monitor and control method previously discussed, the individual server blade of different blade servers can be monitored and controlled.

The invention also provides a remote switch method for blade servers. The remote control station sends a designated signal to the remote control unit through the Internet. The remote control unit transmits a switch signal to the onsite control station, which in turn communicates with the baseboard management controller of a back plane, to transmit the condition of the selected server blade to the remote control station through the same circuit, to monitor and control.

The Internet previously discussed is an Ethernet, and the transmitted signal conforms to Internet protocol.

By means of the remote control system and remote switch control method for blade servers of the invention, the problem of the conventional remote control station that cannot switch different server blades is overcome. The inconvenience of the conventional techniques that have to inform the onsite control station, to switch in advance then to perform monitoring and control on the remote control station, also is eliminated.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a system block diagram of the invention.

FIG. 2 is the flow chart of the control method of the invention.

FIG. 3 is another flow chart of the control method of the invention.

### DESCRIPTION OF THE PREFERRED EMBODIMENTS

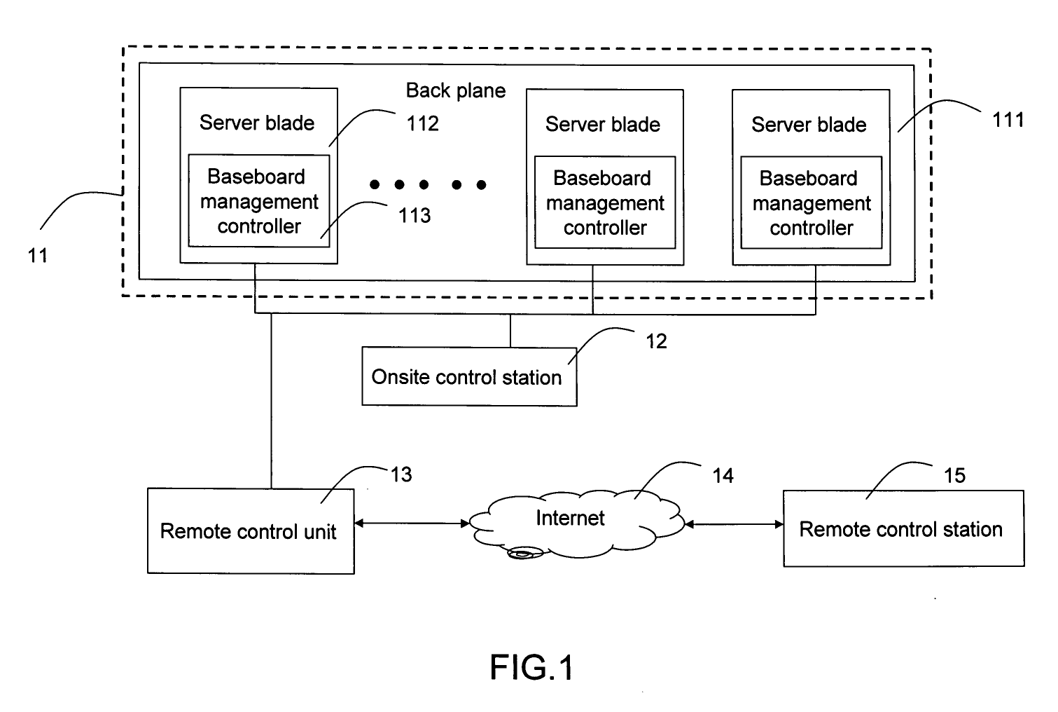

Refer to FIG. 1 for the system block diagram of the invention. The remote control system for blade servers according to the invention includes:

A blade server 11, which includes a back plane 111. The back plane 111 holds a dozen or several dozens of server blades 112, each being a server unit. Hence the blade server 11 contains a plurality of server units and has a powerful calculation and data processing capability. Each server blade 112 has a baseboard management controller 113, to communicate with the back plane 111 and control and manage the server blade 112;

an onsite control station 12 which is monitor and control equipment to monitor and control the blade server 11. It functions as a control center of the server, and is connected to the back plane 111 of the blade server 11. The onsite control station 12 can switch the baseboard management controller 113, to monitor and control each server blade 112. The onsite control station 12 has a keyboard, a video, a mouse and a USB to perform monitoring and control. The remote control station 15 communicates with the baseboard management controller 113 of the back plane 111 through a transmission interface, such as an intellectual platform management bus (IPMB), serial port, parallel port, EIA interface standard RS-232 , peripheral controller interface (PCI), or industry standard architecture (ISA);

We want to control the blade server 11 through a network, apply a remote control unit 13 for controlling the blade server 11. The remote control unit 13 is a signal- conversion and switch equipment and connected to the back plane 111 of the blade server 11, to communicate therewith. It can convert the condition of the back plane 111 to a signal conforming to the Internet protocol (IP) for transmitting outside through the Internet 14 (such as an Ethernet); and

a remote control station 15 which is monitor and control equipment to receive the signal transmitted from the remote control unit 13 through the Internet 14, that conforms to the IP. Similarly. The remote control station 15 also can perform two-way transmission with the remote control unit 13 through the Internet 14. Hence when the remote control station 15 transmits a designated signal, the designated signal is transmitted through the Internet 14 to the remote control unit 13, and the remote control unit 13 receives the signal and connects to the back plane 111, which in turn connects to the baseboard management controller 113 of the designated server blade 112, to perform monitoring and control. The remote control station 15 includes a keyboard, video, mouse and USB to facilitate monitoring and control of each server blade 112.

The remote control unit 13 communicates with the baseboard management controller 113 of the back plane 111 through a transmission interface, such as an intellectual platform management bus (IPMB), serial port, parallel port, EIA interface standard RS-232, peripheral controller interface (PCI), or industry standard architecture (ISA).

In addition to the remote control system for blade servers previously discussed, the invention also provides a matching remote switch control method for blade servers. Details are elaborated below.

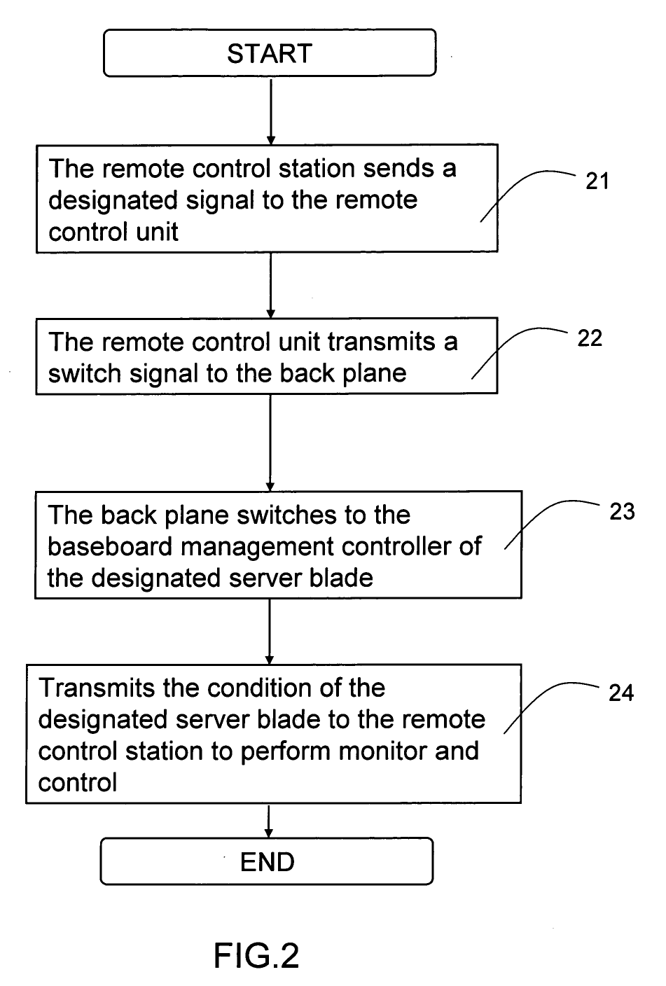

Referring to FIG. 2, first, the remote control station transmits a designated signal to the remote control unit (step 21) through an Ethernet, that conforms to the Internet protocol.

As the remote control unit is connected to the back plane of the blade server, when the remote control unit receives the designated signal, it transmits a switch signal to the back plane (step 22). The back plane switches to the baseboard management controller of the designated server blade (step 23). The baseboard management controller transmits the condition of the designated server blade to the remote controller unit through the back plane, and the remote control unit transmits to the remote control station through the Internet (step 24), to monitor and control the selected server blade.

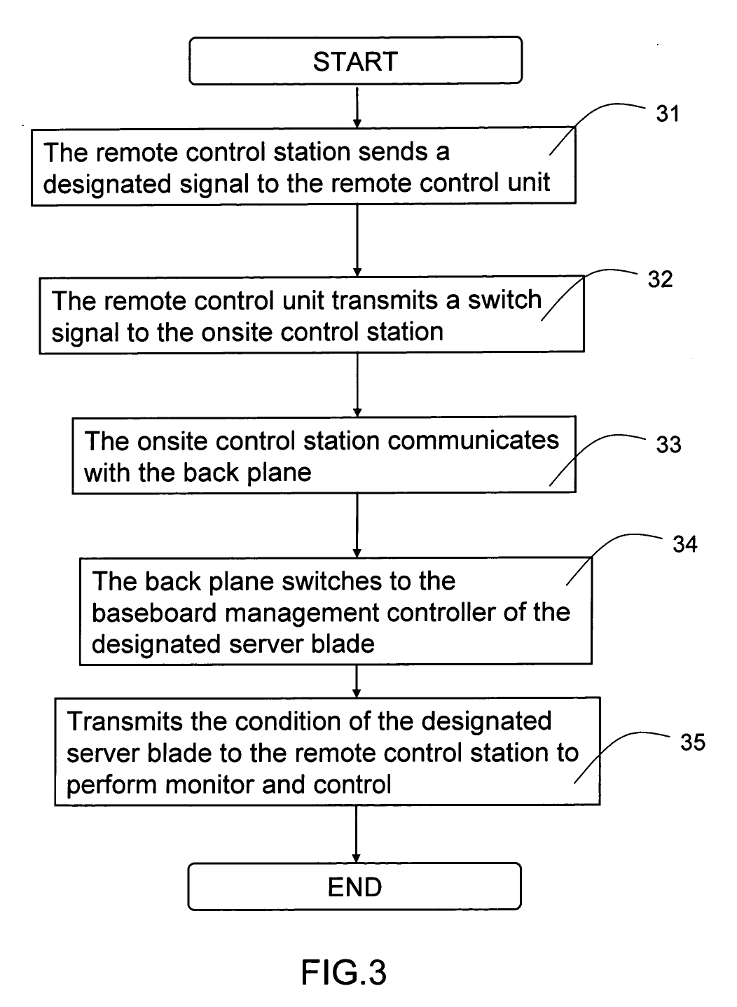

Moreover, the invention also provides a remote switch control method for blade servers. Referring to FIG. 3, the remote control station transmits a designated signal to the remote control unit (step 31). The remote control unit transmits a switch signal to the onsite control station (step 32). The onsite control station communicates with the baseboard management controller of the back plane (step 33). The back-plane switches the baseboard management controller of the server blade (step 34). Finally, the condition of the selected server blade is transmitted through the same circuit to the remote control station (step 35), to perform monitor and control.

If a plurality of blade servers is connected to a system, each blade server has its own remote control unit. The remote control station is first connected to a selected remote control unit, then connected to a selected server blade through the switch control method, set forth above, to perform a monitoring and control function.

By means of the remote control system and remote switch control method for blade servers of the invention, the problem of the conventional techniques that cannot switch different server blades through the remote control station is overcome. The invention can switch different server blades of a blade server, and perform monitoring and control, thus can reduce system shut-down time and the cost of manpower.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments, which do not depart from the spirit and scope of the invention.

What is claimed is:

1. A remote control system for blade servers, comprising:
a blade server which includes a back plane, the back plane holding a plurality of server blades each having a baseboard management controller to control the server blade;
an onsite control station which is a monitor and control equipment to monitor and control the blade server and connected to the back plane to switch each server blade of the back plane to monitor and control the server blade;
a remote control unit which is a signal conversion and switch equipment and connected to the back plane to convert conditions of the back plane to a signal conforming to an Internet protocol (IP) for transmitting outside; and
a remote control station which is a monitor and control equipment to perform two-way transmission with the remote control unit through the Internet;
wherein the remote control station transmits a designated signal to the remote control unit which is connected to the back plane, the back plane being connected to the designated server blade to perform monitor and control.

2. The remote control system of claim 1, wherein the Internet is a high speed Ethernet.

3. The remote control system of claim 1, wherein the remote control unit includes a network card which conforms to a high speed Ethernet transmission interface.

4. The remote control system of claim 1, wherein the onsite control station includes a keyboard, a video, a mouse and a universal serial bus (USB).

5. The remote control system of claim 1, wherein the remote control station includes a keyboard, a video, a mouse and a universal serial bus (USB).

6. The remote control system of claim 1, wherein the onsite control station and the remote control unit communicate with the baseboard management controller of the back plane through a transmission interface selecting from the group consisting of an intellectual platform management bus (IPMB), a serial port, a parallel port, an EIA interface standard RS-232, a peripheral controller interface (PCI), and an industry standard architecture (ISA).

7. The remote control system of claim 1, wherein the remote control unit is connected to the onsite control station and receives conditions of the server blade of the back plane connecting to the onsite control station, and converts the conditions to a signal conforming to an Internet protocol (IP) for transmitting to the remote control station.

8. A remote switch control method for blade servers, comprising the steps of:
transmitting a designated signal from a remote control station to a remote control unit through the Internet in a two-way fashion;
connecting the remote control unit to a baseboard management controller of each back plane of a blade server, and transmitting a switch signal from the remote control unit to the baseboard management controller of a selected back plane, the baseboard management controller transmitting conditions of a designated server blade on the back plane to the remote control unit; and
transmitting the received conditions of the server blade from the remote control unit to the remote control station through the Internet, monitoring and controlling the selected server blade by the remote control station.

9. The remote switch control method of claim 8, wherein the remote control unit is connected to the baseboard management controller of each back plane of the blade server and the onsite control station, and the onsite control station is connected to the baseboard management controller of each back plane of the blade server to perform two-way transmission.

10. The remote switch control method of claim 8, wherein the onsite control station and the baseboard management controller of the back plane communicate through a transmission interface selecting from the group consisting of an intellectual platform management bus (IPMB), a serial port, a parallel port, an EIA interface standard RS-232, a peripheral controller interface (PCI), and an industry standard architecture (ISA).

11. The remote switch control method of claim 8, wherein the Internet is a high speed Ethernet.

12. The remote switch control method of claim 8, wherein the remote control station and the baseboard management controller of the back plane communicate through a transmission interface selecting from the group consisting of an intellectual platform management bus (IPMB), a serial port, a parallel port, an EIA interface standard RS-232, a peripheral controller interface (PCI), and an industry standard architecture (ISA).
